(19) United States
(12) Patent Application Publication
(10) Pub. No.: US 2018/0011255 A1
(43) Pub. Date: Jan. 11, 2018

(54) User-Friendly USB Connectors with Fiber-Optical Connections

(71) Applicant: Joseph Lai, San Pedro, CA (US)

(72) Inventor: Joseph Lai, San Pedro, CA (US)

(21) Appl. No.: 14/562,640

(22) Filed: Dec. 5, 2014

(51) Int. Cl. G02B 6/38; H01R 24/64; H01R 107/00

(52) U.S. Cl. CPC G02B 6/3817; G02B 6/3893; H01R 24/64; G02B 6/3863; G02B 6/3885; H01R 2107/00

(57) ABSTRACT

Performances are enhanced and improved tremendously for existing USB connectors with new improvised fiber-optical connection features and their capabilities. Existing USB connectors, such as user-friendly reversible Type-A and USB Type-C connectors are modified, improvised and retrofitted using means of allocating unused spaces and surfaces to allow fiber-optical wires and connections inside the user-friendly reversible Type-A and USB Type-C connectors. This modification will not affect the regular functions and performances of the user-friendly reversible Type-A and USB Type-C connections. New fiber-optical connections will enhance and improve reversible Type A and USB Type-C as compared to regular user-friendly reversible Type-A and Type-C connectors that have only copper wire connections. They are faster in speed, with the capability of much more bandwidth, longer transmission distance, lighter weight, water proof with corrosion resistance, better data security, immunity to electro-magnetic interference (EMI) and generating no EMI noise, lower cost, less wear and tear for longer life, better safety with non-conductive connectors, and much more.

### CROSS-REFERENCES

This application incorporates by reference the U.S. Pat. No. 7,717,717 “User-Friendly USB Connector” in its entirety. Joseph Lai is the sole inventor of the U.S. Pat. No. 7,717,717 and the invention is disclosed in this application.

### FIELD OF THE INVENTION

This present invention is related to improve the existing USB connectors with a smart, faster, low-cost and better way of transporting data with fiber-optical connections for personal computing, smartphones and all suitable applications.

### BACKGROUND OF THE INVENTION

Why is this invention necessary?

The Problems:

Copper wire-based electrical connections in the existing USB connectors are too expensive, heavy, and bulky. They run slow, support only short distances, can be corrosive, and present bad EMI problems for carrying high-speed data. Typically, USB connection signals with twisted pairs are poorly terminated and shielded. Specifically, the newer version of USB3.0/3.1 runs at 4.8/9.6 Giga bits/second, with the connection generating tremendous electro-magnetic interference (EMI) right on the popular licensing free ISM (Industrial, Scientific, Medical) bands. This causes Wi-Fi, Bluetooth and other RF devices to malfunction. For computers connecting to high speed peripherals, such as hard disk drives, high resolution video monitors and special data processing equipment, copper wires surely are yesterday's solution. The computer industry has wasted a lot of valuable resources in copper based wires. For example, in the early 80's, computers were connected to printers by a Centronics standard of 36 wire connectors. IBM reduced it to 25 wires, and then the serial port became 9 wires. Finally, USB came along and only used 4 wires (half-duplex) with its 1.0 and 2.0. Then for higher speed's sake, USB 3.0 came with 9 half-duplex plus 2 more pairs of full-duplex copper wires, and the USB 3.1 Type-C went back to 12 wires. Copper wires still seemed like the only solution for personal computing and smartphone applications with the many problems which were mentioned earlier.

The Solution

Add fiber-optical connection capability to the existing copper wire based USB connectors. Maintain the current compatibilities with all the existing, popular old USB connectors to keep it low-cost and environmentally friendly, and add all the benefits that fiber-optics offers to create the new USB connector.

### SUMMARY OF THE INVENTION

This present invention will provide a new super bandwidth fiber-optical connection to the existing popular USB connectors without affecting the original USB performance. The fiber-optical connection contact points are provided on the unused surfaces at both the male plug and the female receptacle in conspicuous locations. When the fiber-optically equipped USB plug and receptacle mates, fiber-optic connection contact points are aligned, engaged and connected. Newly fiber-optical equipped USB connectors, such as USER-FRIENDLY reversible Type-A and Type-C connectors, are 100% compatible with both the old USB copper wires connectors and the fiber-optical connections, plus they are still reversible.

### BRIEF DESCRIPTION OF THE DRAWINGS

FIG. 1. (Prior Art) of the existing “User-Friendly” Reversible type-A connector has no fiber-optical connection

FIG. 2. (Prior Art) of the existing regular USB Type-C, Reversible connector has no fiber-optical connection

FIG. 3. Modified “User-Friendly” Reversible USB type-A with fiber-optical connections

FIG. 4. Modified “User-Friendly” Reversible USB type-A with fiber-optical connections mating together

FIG. 5. Modified USB Type-C connectors with the fiber-optical connections.

FIG. 6. Modified USB Type-C connectors with the fiber-optical connections mating together

### DETAILED DESCRIPTION

The fiber-optical wire/connector has been a well proven low-cost technology for transmitting massive amounts of high-speed data for connecting phone conversations, internet data, scientific research and many other applications for over 50 years. Fiber-optic is still not used in the personal computing or popular smartphone applications. However, the demands of high-speed for personal computing or smartphones are going strong. Copper wires have pretty much reached the limit of their transmission speed. Transmission speed is not the only concern. Copper wires have a lot of problems for the cost, the weight, the reliability, the EMI and many other issues. Also, unlike the copper connectors, for fiber-optical connectors, no expensive gold plating is required and there is no tooling for the metal stamping the contact pins. No metal pin means this is zero insertion force (ZIF) for inserting or detaching, which fiber-optical connection won't scratch the contact surfaces/points, fiber-optical connections is much more durable and last much longer than conventional electrical connectors.

Overall summarized advantages of fiber-optical connections:
Much higher bandwidth, 100× or more compares to copper wires
Longer distance without repeaters, fiber-optical signal is not easily attenuated
Lighter in weigh, great for many applications such as avionic, space exploration
Non-corrosive, fibers are made of either glass or plastic so it won't rust, oxide
Better security, fiber-optical wire or connections are extremely difficult to tap, no problems with cross-talk
No problems with EMI, fiber-optical connections won't generate EMI noises and won't pickup EMI noises either
More durable, to connect fiber no need for two surface of metal to scratch at each other
Safer, fiber-optical is not conductive, therefore, no troubles with lightning, leaked and/or induced dangerous high voltage could hurt people or animal
Lower cost, making fiber-optical wire is easier and signal boosting is less required compares to copper wire . . . expensive gold plating is not necessary, no twisted pairs, shielding or termination are not required . . . no problems with impedance matching . . .
Fiber-optical wires and connections are the best for connecting future generation optical computers

However, with so many advantages, fiber-optical wires and connectors:
Must aligned perfectly at the mating point at the right angle for the best performance
The contact surfaces of the cores must be polished and keep it clean and the shortest distance from each ends when mate
Bending radius of fiber-optical wire must follow the specification of manufacturer
To improvise the existing USB connectors with fiber, additional hardware and software maybe required
Must be careful with the strong light to avoid injury to eyes

Meanwhile, there has been nothing more successful than the USB (Universal Serial Bus) connectors. They reached 4 Billion pieces in sales as of 2013. USB connection is a standard and has been Government mandated in many countries for cellular phone charging purposes. For a new fiber-optical connector for the above mentioned applications, it is obvious we should use the popular USB connector style as the base. It can be retrofitted with the fiber-optical capability instead of re-inventing the wheel and designing a new style of connector. The “combo” or “hybrid” connector not only works for the newly invented fiber-optical advantages, but also maintains the existing USB compatibility for a user-friendly, smoother conversion for both economical and environmental reasons. In the long run, when the computer and peripheral become standard equipped with the fiber-optical drivers or controllers, copper wires can be totally eliminated to save the cost of the “combo” or “hybrid”. In other words, since copper wires are at least 100 times slower than fiber-optical wires, fiber-optical wires will replace the copper wires, at some point we will be able to use the same USB metal housing and the spacer plastics to hold the fiber-optical wires without needing the copper contact pins.

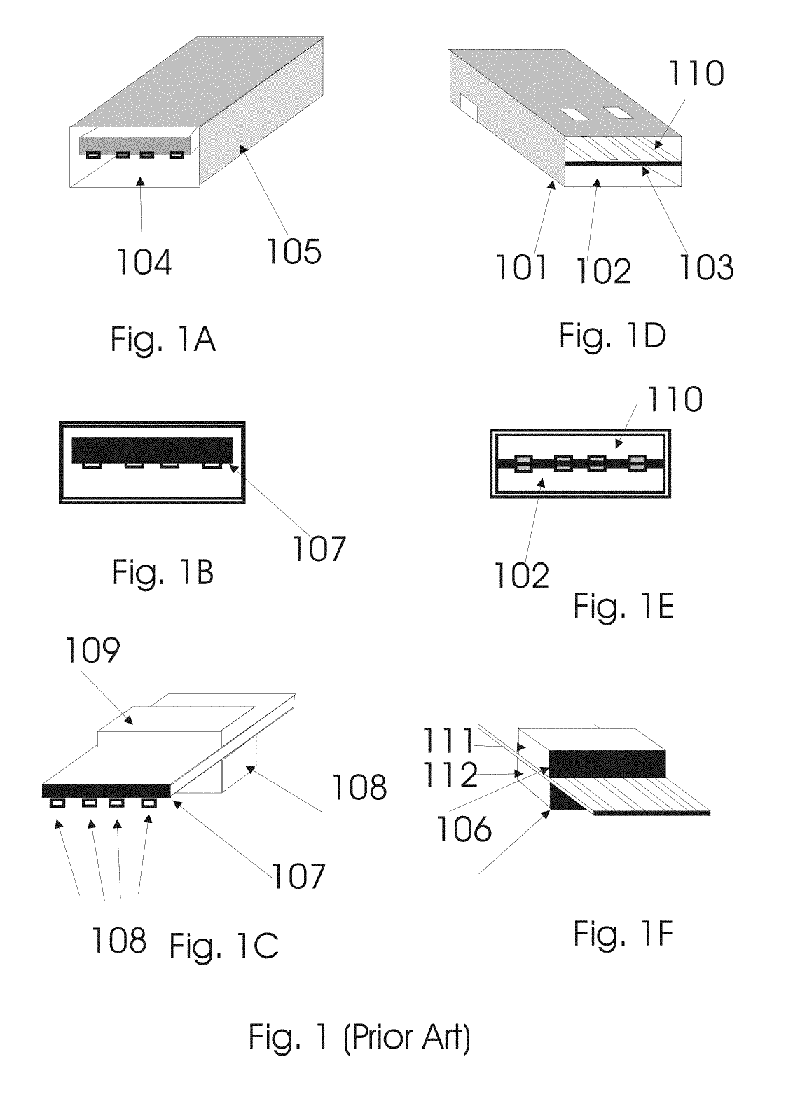

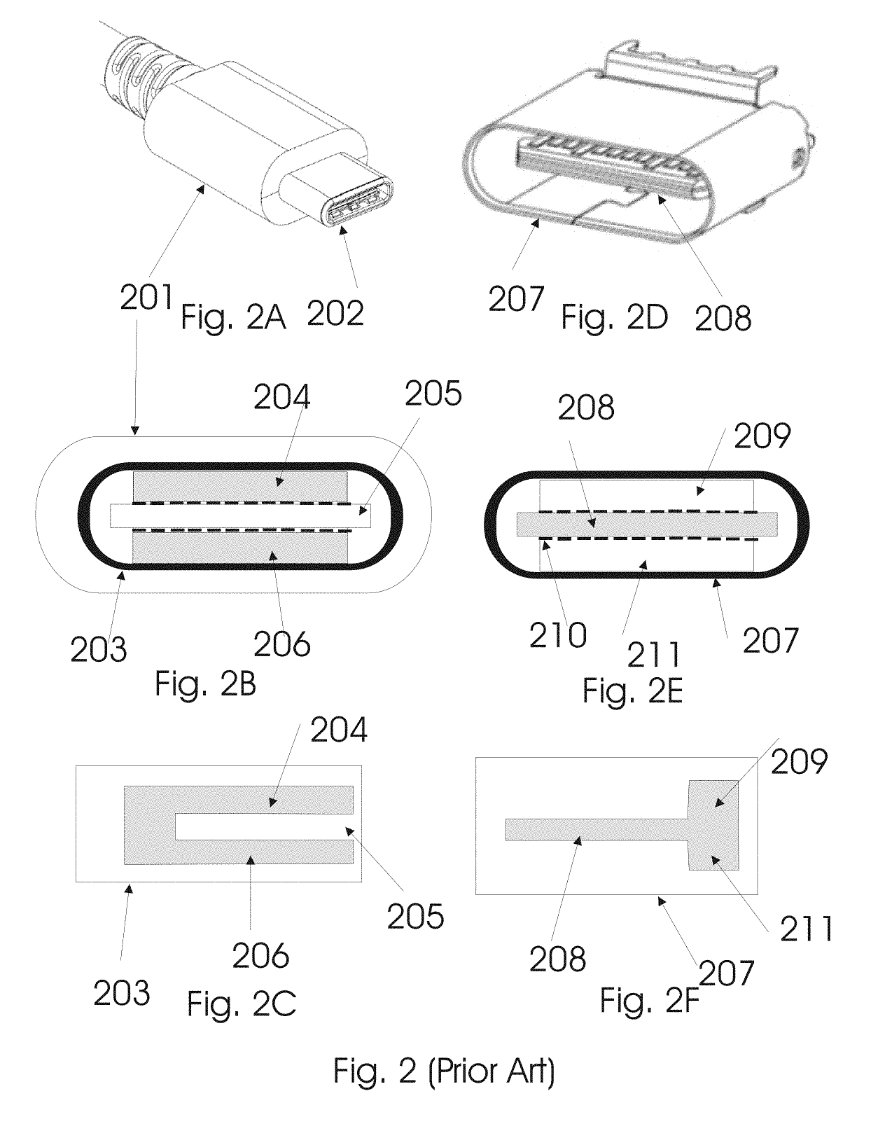

FIG. 1, shows prior art of the “reversible” Type-A without fiber-optical capability which invented by the same inventor and FIG. 2 shows the newly developed USB Type-C without the fiber-optical capability which is also happened to be USER-FRIENDLY as “reversible”. FIG. 1A is the regular USB Type-A female receptacle with metal housing (105) and the space (104) for the reversible USB Type-A male plug (FIG. 1D) to plug-in. (103) is the male tongue which is thin, rigid and flat. The reversible USB Type-A male plug has space (102) on the bottom and space (110) on top so it is reversible and can plug in to the regular USB Type-A female receptacle in either orientation.

FIG. 1B is the front view of the regular USB Type-A female receptacle with female floating tongue (107) which holding the spring loaded copper contact pins for making connection when the reversible USB Type-A is inserted in. FIG. 1E shows the front view of the reversible USB Type-A with space (102) (110) evenly on top and bottom. FIG. 1C removes the metal housing of the regular USB Type-A female receptacle. Note the (109) is the top spacer and (108) is the bottom spacer which are not the same thickness. (107) is the floating tongue now exposed with 4 contact points (108). FIG. 1F shows the reversible USB Type-A male, without metal housing (101). The reversible USB Type-A male plug has a male tongue which supported by two spacers (111) (112) to hold it inside the middle of the metal housing. (106) is the “mating surface” of the reversible USB Type-A male plug, (106) will touch (107) when the male plug and female receptacle mate together.

FIG. 2 contains also prior art of the newly developed USB Type-C connectors. FIG. 2A shows the male plug with plastic holder (201) and the USB Type-C connector 202. FIG. 2B shows the front view of the USB Type-C which has the spacers (204) on top and (206) on bottom. (205) is the cavity to allow the female tongue (208) to go in and mate. (203) is the oval-shaped metal housing which protects and shield the plastic and all metal pins. FIG. 2C is the X-ray vision of side view, from this angle, inside USB Type-C (204) and (206) forms a horseshoe to allow reversibility with contact pins on both top (204) and bottom (206). FIG. 2D shows the 3D view of the USB Type-C female receptacle. (208) is the floating tongue with metal housing (207) for (203) to mate. FIG. 2E shows the front view of the USB Type-C female receptacle with floating tongue (208) right in the middle supported by base spacer (209) on the top and (211) on the bottom and put together with the metal housing (207). (210) is one of the contact pins for making electrical connection. Two rows of 12 pins are showing but only one row is necessary for connecting the USB Type-C male plug and female receptacle. The male plug has 24 pins with 12 on the top and 12 on the bottom as the reversibility requires. FIG. 2F is the X-ray side view of the USB Type-C female receptacle with the floating tongue sticks (208) for mating with the horseshow of the male plug of the USB Type-C male plug.

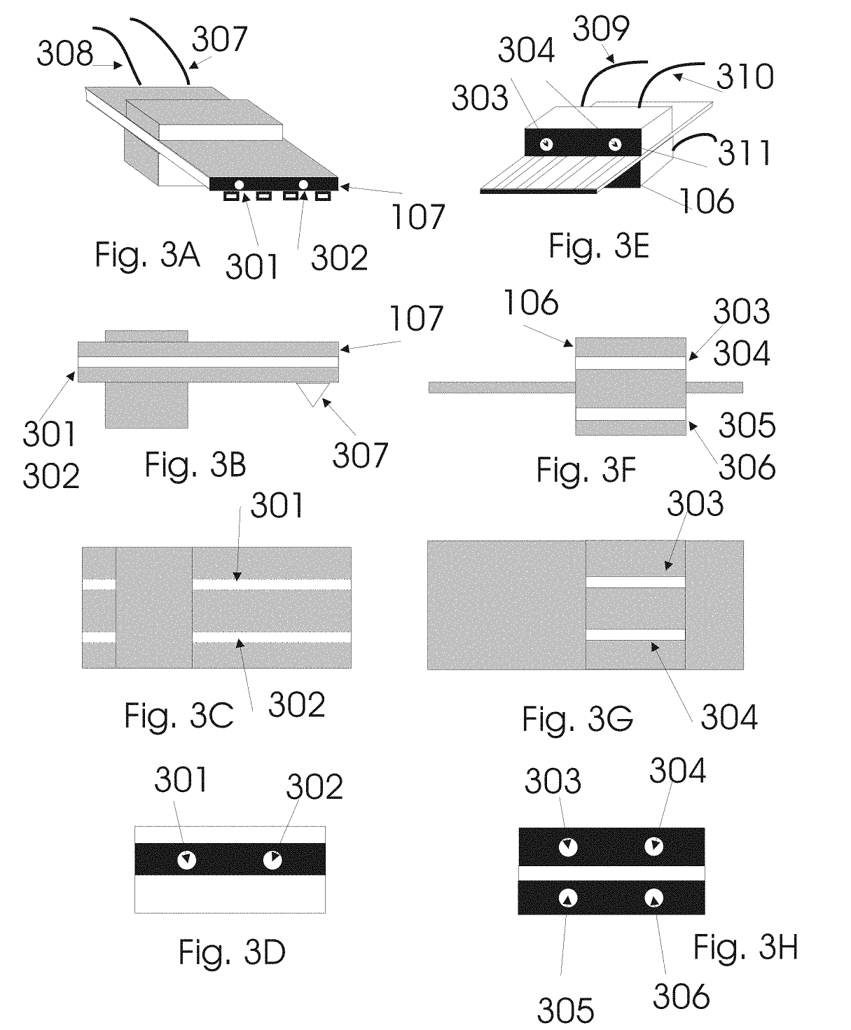

FIG. 3 shows the improvised fiber-optical function now equipped in the regular reversible USB male plug and female receptacle. FIG. 3A shows the 3D view of the regular USB Type-A female receptacle without metal housing; Notice 301 and 302 are small holes on the tip of the tongue (107). Fiber-optical wires (308) (309) goes in from the back side of the tongue and reached to the holes (301) and (302) to allow lights to go through. FIG. 3B is the side view of the regular USB Type-A female receptacle assembly without the metal housing with the spring loaded pins (307) and the modified/drilled channels (301) and (302) to allow fiber-optical wires to go through and reach the tip of the tongue (107). FIG. 3C shows the top view with 2 channels (301) (302) for fiber-optical wires. FIG. 3D shows the front view of the modified USB Type-A female receptacle without metal housing and notice the (301) and (302) has the holes to allow fiber-optical cable to conduct light or optical signal connections. FIG. 3E is the 3D view of the reversible USB male plug without metal housing. (303) and (304) are holes to allow the fiber-optical wires (309) (310) to expose on the mating surface (106). FIG. 3F shows the side view of the reversible USB male plug with two pairs of channels (303) (304) and (305) (306) to allow the fiber-optical wires. FIG. 3G shows the top view of the reversible USB male plug with (303) (304) as holding channels. FIG. 3H shows the front view of the reversible USB male plug without metal housing with the exposed holes (303) (304) and (305) (306) for fiber-optical wires to terminate and expose.

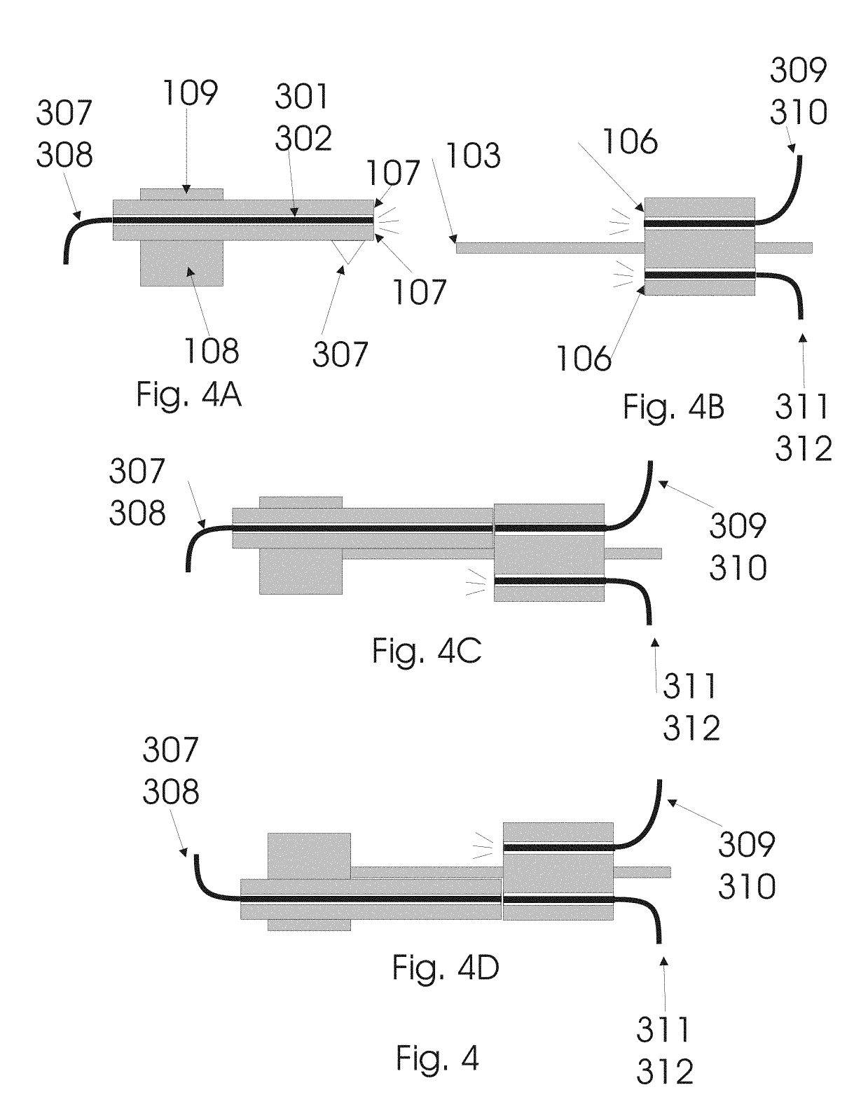

FIG. 4 shows how the reversible USB Type-A male plug and the regular USB female receptacle mate, making both electrical and optical connections. FIG. 4A is the side view of the regular USB Type-A female receptacle and FIG. 4B is the side view of the reversible USB Type-A male plug. FIG. 4C is one of the orientations when the male plug and female receptacle mate and FIG. 4D is the reverse mate with female receptacle on the bottom. When mating in the normal position, (309) (310) and (307) (308) making contacts. When mating in the reverse position, (307) (308) and (311) (312) make fiber-optical connections. Notice two pairs are required for full-duplex of fiber-optical connections one can be used for transmitting and the other for receiving data. In half-duplex mode, only 1 pair is required for both transmitting and receiving by sharing the same fiber-optical wires. Only 1 hole with 1 fiber-optical wire in the middle of top and bottom on the spacer is required.

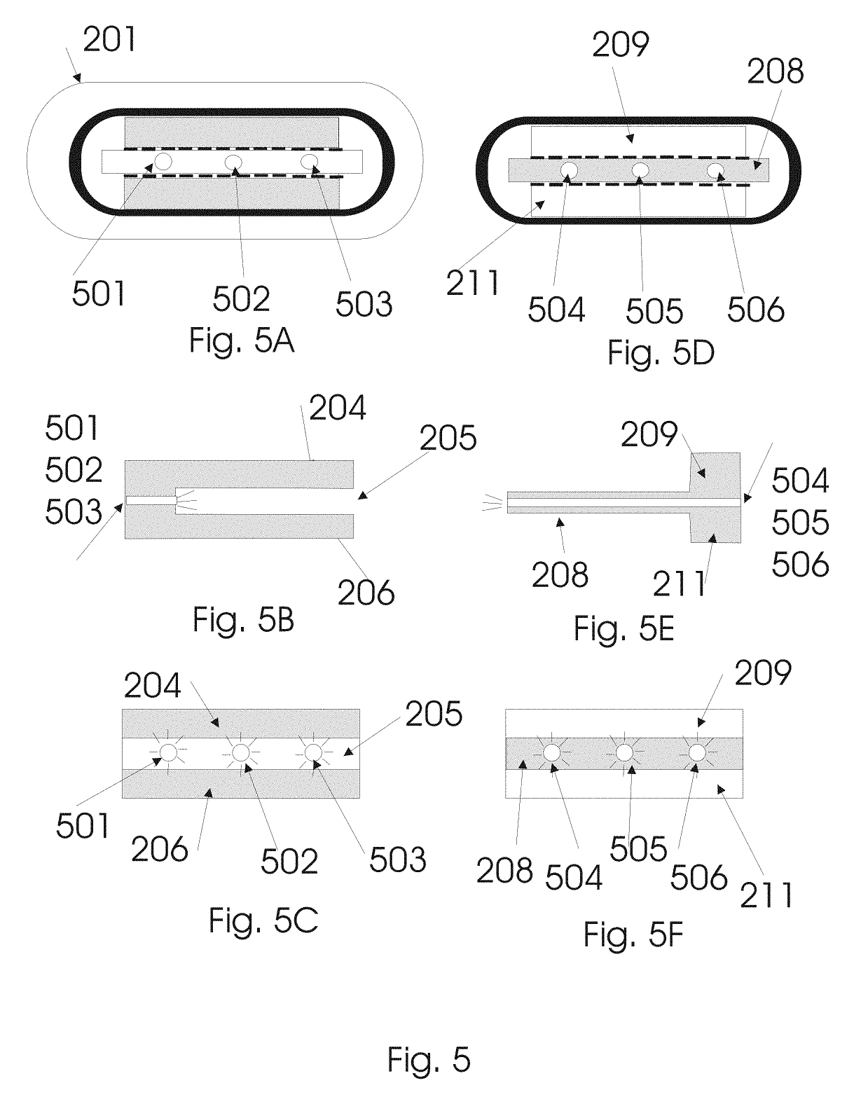

FIG. 5 shows the USB Type-C connector now modified for fiber-optical capability, FIG. 5A shows the USB Type-C male plug now equipped with 3 holes (501) (502) (503) for fiber-optical connections. FIG. 5B shows the side view of the USB Type-C male plug without metal housing. It looks like a horseshoe with cavity (205) and support (204) and (206). The holes are in the back of the horseshoe (501) (502) and (503). FIG. 5C is the front view of the USB Type-C male plug with the fiber-optical holes (501) (502) and (503). FIG. 5D is the USB Type-C female receptacle with equipped holes (504) (505) (506) on the tip of the tongue (208). FIG. 5E shows the side view of the USB type-C female receptacle without metal housing with holes (504) (505) (506) drilled from back to the tip on the tongue (208) and supported by base spacers (209) on top and (211) on bottom. FIG. 5F shows the front view of the USB Type-C female receptacle has the holes (504) (505) (506) on tip of the tongue (208) and supported by base spacers (209) on top and (211) on bottom.

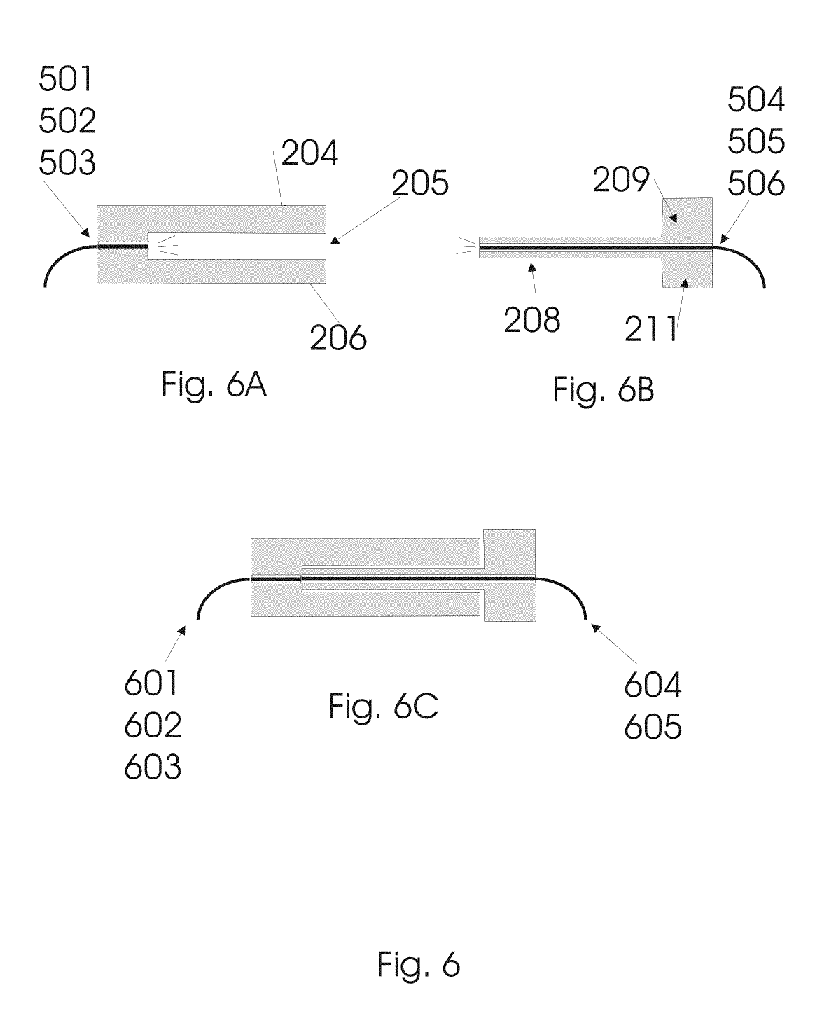

FIG. 6 shows how the USB Type-C male plug and the USB Type-C female receptacle connector mate and making not only electrical connections (as Type-C's normal specifications) but also making fiber-optical connections as well. FIG. 6A is the USB Type-C male plug horseshoe shaped with holes provided (501) (502) (503) on the plastic holder without metal housing. FIG. 6B is the USB type-C female receptacle with holes through channels on the tongue. FIG. 6C shows the male plug and female receptacle mate with fiber-optical wires (601) (602) (603) and (604) (605). Since the USB Type-C is also reversible, for half-duplex operation, only hole (502) in the middle on the USB type-C male plug and hole (505) also in the middle on the USB Type-C female receptacle is necessary which is plenty bandwidth for normal users with reversibility. For full-duplex operation, additional holes are required as hole (502) always mates with hole (505) but for the full-duplex operation, one more pair of holes is required. In the normal mating position, hole (501) mating with (506) but in the reverse position, hole (501) will mate with hole (504), It is suggested that fiber-optical wires with male plug have 2 fiber wires but the female receptacle on the computer has 3 wires to save cost.

### CONCLUSION

I claim:

1. A USB connector with fiber-optical connections, comprising:
a. a plurality of matching holes on the mating surfaces of both male plug and female receptacle inside of said USB connectors,
b. a plurality of supporting channels with exposed said matching holes on said mating surfaces to hold and guide the fiber-optical wires to reside inside of un-used space of said male plug and said female receptacle of said USB connectors,
c. a plurality of terminated of said fiber-optical wires to expose the ends on said mating surfaces through said matching holes which are held and guided by said supporting channels on both said male plug and said female receptacle and
wherein said fiber-optical connections are provided, when said male plug and said female receptacle mate, for USB Type-A, reversible USB Type-A, USB Type-B, mini USB, micro USB and USB Type-C connectors.

2. The fiber-optical connection in claim 1, wherein said matching holes on said mating surfaces must be aligned precisely from said male plug to said female receptacle when they mate to have the best performances of said fiber-optical connections.

3. The fiber-optical connection in claim 1, wherein said reversibility is possible for said USB Type-C and said reversible USB Type-A with or without spare said matching holes to have said fiber-optical connections when said male plug is plugging into said female receptacle in reverse mode.

4. The fiber-optical connection in claim 1, wherein said fiber-optical wires are terminated at each said ends of said male plug and female receptacle, and polished to expose at said matching holes on said mating surfaces to make the best of said fiber-optical connections inside said USB reversible or non-reversible connectors.

5. The fiber-optical connection in claim 1, wherein said exposed ends of said fiber-optical wires on said male plug and said female receptacle are clean and kept in the shortest distance from said mating surfaces of said male plug and female receptacle for the best said fiber-optical connections.

6. The fiber-optical connection in claim 1, wherein said fiber-optical connection can be used as a backup connection in case of its normal electrical connections failed.

7. The fiber-optical connection in claim 1, wherein said fiber-optical connections are electro-magnetic interference (EMI) proof, no shielding or groundings are required.

8. The fiber-optical connection in claim 1, wherein said fiber-optical wires are made of glass or plastic.

9. The fiber-optical connection in claim 1, wherein said fiber-optical connections are for optical and electrical computers.

10. The fiber-optical connection in claim 1, wherein said fiber-optical wires are eliminating and replacing conventional copper wires inside said USB connectors.

11. A method of USB connector with fiber-optical connections, comprising the steps of:
a. Providing a plurality of matching holes on the mating surfaces of both male plug and female receptacle inside of the USB connectors,
b. Providing a plurality of supporting channels with exposed said matching holes on said mating surfaces to hold and guide the fiber-optical wires to reside inside of un-used space of said male plug and said female receptacle of said USB connectors,
c. Providing a plurality of terminated of said fiber-optical wires to expose the ends on said mating surfaces through said matching holes which are held and guided by said supporting channels on both said male plug and said female receptacle and
wherein said method of fiber-optical connections are provided, when said male plug and said female receptacle mate, for USB Type-A, reversible USB Type-A, USB Type-B, mini USB, micro USB and USB Type-C connectors.

12. The method of fiber-optical connection in claim 11, wherein said matching holes on said mating surfaces must be aligned precisely from said male plug to said female receptacle when they mate to have the best performances of said fiber-optical connections.

13. The method of fiber-optical connection in claim 11, wherein said reversibility is possible for said USB Type-C and said reversible USB Type-A with or without spare said matching holes to have said fiber-optical connections when said male plug is plugging into said female receptacle reversely.

14. The method of fiber-optical connection in claim 11, wherein said fiber-optical wires are terminated at each said ends and polished to expose at said matching holes on said mating surfaces to make the best of said fiber-optical connections inside said USB reversible or non-reversible connectors.

15. The method of fiber-optical connection in claim 11, wherein said exposed ends of said fiber-optical wires on said male plug and said female receptacle are clean and kept in the shortest distance from said mating surfaces of said male plug and female receptacle for the best said fiber-optical connections.

16. The method of fiber-optical connection in claim 11, wherein said fiber-optical connection can be used as a backup connection in case of its normal electrical connections failed.

17. The method of fiber-optical connection in claim 11, wherein said fiber-optical connections are electro-magnetic interference (EMI) proof, no shielding or groundings are required.

18. The method of fiber-optical connection in claim 11, wherein said fiber-optical wires are made of glass or plastic.

19. The method of fiber-optical connection in claim 11, wherein said fiber-optical connections are for optical and electrical computers.

20. The method of fiber-optical connection in claim 11, wherein said fiber-optical wires are eliminating and replacing conventional copper wires inside said USB connectors.
